(19) United States
(12) Patent Application Publication
(10) Pub. No.: US 2024/0401617 A1
(43) Pub. Date: Dec. 5, 2024

(54) SYSTEMS AND METHODS FOR RECOVERING AND UTILIZING WASTE ENERGY IN A WORK VEHICLE

(71) Applicant: CNH Industrial America LLC, New Holland, PA (US)

(72) Inventor: Andrew Tarman, Dover, PA (US)

(21) Appl. No.: 18/204,633

(22) Filed: Jun. 1, 2023

(51) Int. Cl. F15B 21/0423; F15B 15/18; H01M 10/44; H01M 10/48; H01M 10/615; H01M 10/625; H01M 10/63; H01M 10/6568

(52) U.S. Cl. CPC F15B 21/0423; F15B 15/18; H01M 10/44; H01M 10/486; H01M 10/615; H01M 10/625; H01M 10/63; H01M 10/6568; H01M 2220/20

(57) ABSTRACT

In one aspect, the present subject matter is directed to a system for exchanging heat to support operation of an electrical system. The system includes a hydraulic actuator structured to receive a pressurized hydraulic fluid and convert a pressure energy in the pressurized hydraulic fluid to mechanical force. A hydraulic fluid circuit is used in conjunction with the hydraulic actuator. The hydraulic fluid circuit is structured to contain the pressurized hydraulic fluid and transmit the pressure energy to the hydraulic actuator. The hydraulic fluid circuit is also configured to absorb a waste heat produced as a result of operation of the hydraulic actuator. A heat exchange fluid circuit is in thermal communication with the hydraulic fluid circuit, where the heat exchange fluid circuit is structured to contain a heat exchange fluid. An energy storage device is in thermal communication with the heat exchange fluid.

### FIELD OF THE INVENTION

The present disclosure relates generally to work vehicles, and, more particularly, to systems and methods for utilizing waste heat for work vehicles.

### BACKGROUND OF THE INVENTION

A work vehicle, such as a wheel loader, skid steer loader, backhoe loader, compact track loader, farm vehicle with hydraulic actuators, and the like, typically includes a hydraulic system to actuate various components of the vehicle. For example, the hydraulic system may raise and lower an implement, such as a bucket, at the operator's command. As such, the hydraulic system generally includes one or more hydraulic actuators and a pump configured to supply hydraulic fluid to the actuator(s).

The work vehicle can also include one or more energy storage devices useful to augment and/or provide primary power to one or more systems of the work vehicle. The energy storage devices can be used in a hybrid configuration (e.g., used alongside an internal combustion engine) or can be used in an all-electric configuration. The energy storage devices will experience a range of operating conditions during which time the energy storage devices may discharge to provide power to a component of the work vehicle, or may accept a charge to restore power lost when discharging. During some operations, such as when operating in cold environments, the energy storage devices may be less than efficient in accepting a charge to restore lost power.

Accordingly, systems and methods for promoting heat exchange with energy storage devices that address one or more of the issues present in the prior art would be welcomed in the technology, including, for example, systems and methods that provide for harvesting waste energy for use with the energy storage devices.

### SUMMARY OF THE INVENTION

Aspects and advantages of the technology will be set forth in part in the following description, or may be obvious from the description, or may be learned through practice of the technology.

In one aspect, the present subject matter is directed to a system for exchanging heat to support operation of an electrical system. The system includes a hydraulic actuator structured to receive a pressurized hydraulic fluid and convert a pressure energy in the pressurized hydraulic fluid to mechanical force. The system also includes a hydraulic fluid circuit structured to contain the pressurized hydraulic fluid and transmit the pressure energy to the hydraulic actuator. The hydraulic fluid circuit can also be configured to absorb a waste heat produced as a result of operation of the hydraulic actuator. A heat exchange fluid circuit can also be provided in the system which is in thermal communication with the hydraulic fluid circuit, the heat exchange fluid circuit structured to contain a heat exchange fluid. The system can also include an energy storage device in thermal communication with the heat exchange fluid. As a result of the energy storage device being in thermal communication with the heat exchange fluid, the heat exchange fluid can transfer the waste heat from the pressurized hydraulic fluid to the energy storage device.

In another aspect, the present subject matter is directed to a system for transferring waste energy which includes a work vehicle configured to generate a waste energy as a result of operation of the work vehicle. The work vehicle can include a heat exchange fluid circuit in thermal communication with a source of the waste energy, the heat exchange fluid circuit structured to contain a heat exchange fluid. The work vehicle can also include an energy storage device in thermal communication with the heat exchange fluid. As a result of the energy storage device being in thermal communication with the heat exchange fluid, the heat exchange fluid transfers the waste energy between the source of waste energy and the energy storage device.

In a further aspect, the present subject matter is directed to a method for using waste heat. The method can include operating a hydraulic actuator during operation of a work vehicle. The method can also include absorbing waste heat into a hydraulic fluid as a result of operating the hydraulic actuator. The method can further include transferring the waste heat into a heat exchange fluid and warming an energy storage device with the waste heat in the heat exchange fluid.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a side view of one embodiment of a work vehicle in accordance with aspects of the present subject matter;

FIG. 2 illustrates a schematic view of one embodiment of a hydraulic system and an electric system in thermal communication in accordance with aspects of the present subject matter:

FIG. 3 illustrates a schematic view of one embodiment of an electric system controller in accordance with aspects of the present subject matter;

FIG. 4 illustrates a flow chart of one embodiment of the electric system controller in accordance with aspects of the present subject matter.

FIG. 5 illustrates a schematic view of one embodiment of a computing system for communicating with a sensor in accordance with aspects of the present subject matter; and

FIG. 6 illustrates a flow diagram of one embodiment of a method for using waste heat in accordance with aspects of the present subject matter.

FIG. 7 illustrates a flow diagram of one embodiment of a method for using waste heat.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield still a further embodiment. Thus, it is intended that the present invention covers such modifications and variations as come within the scope of the appended claims and their equivalents.

In general, the present subject matter is directed to a system for exchanging heat for operation of an electrical system. As will be described below, the system may include a hydraulic actuator coupled with a hydraulic fluid circuit. The hydraulic fluid circuit can be structured to contain a pressurized hydraulic fluid, or, simply, a hydraulic fluid, and transmit the pressure energy in the pressurized hydraulic fluid to the hydraulic actuator. The hydraulic fluid circuit can be configured to absorb a waste heat produced as a result of operation of the hydraulic actuator. Additionally, the system may also include a heat exchange fluid circuit in thermal communication with the hydraulic fluid circuit, as well as an energy storage device in thermal communication with the heat exchange fluid. The heat exchange fluid can transfer the waste heat from the hydraulic fluid to the energy storage device.

The disclosed system may provide one or more technical advantages. More specifically, providing waste heat to the heat exchange fluid so that it may be used to warm the energy storage device aids in thermally conditioning the energy storage device to accept a charge during low temperature operating conditions. Such an ability can aid in preventing damage to the energy storage device and/or improving efficiency during a charging event.

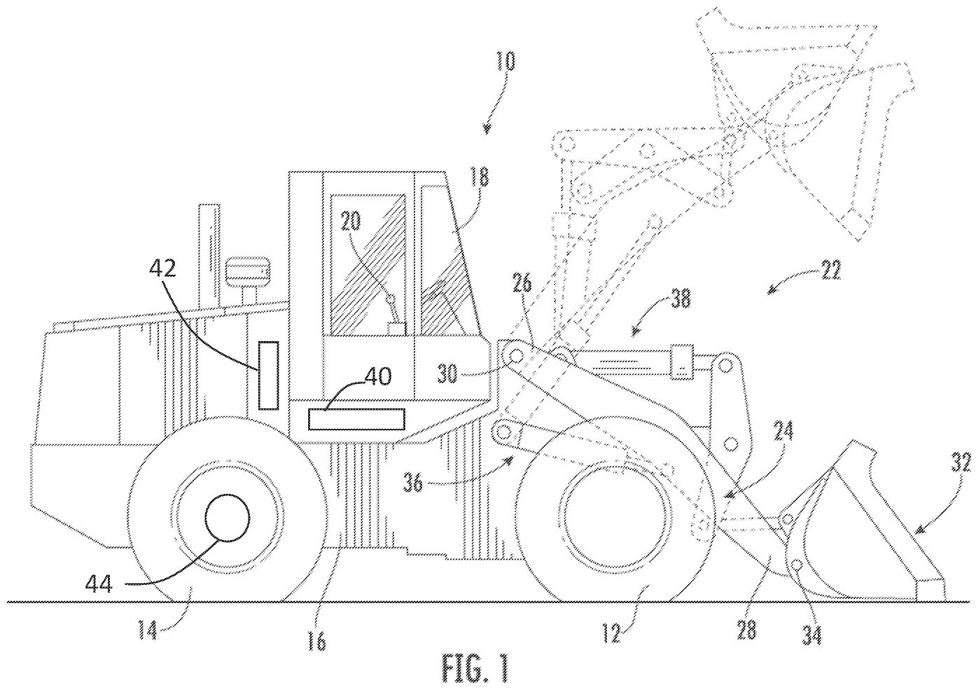

Referring now to the drawings, FIG. 1 illustrates a side view of one embodiment of a work vehicle 10. As shown, the work vehicle 10 is configured as a wheel loader. However, in other embodiments, the work vehicle 10 may be configured as any other suitable work vehicle known in the art, such as any other work vehicle including movable loader arms (e.g., any other type of front loader, such as skid steer loaders, backhoe loaders, compact track loaders, farm vehicle with hydraulic actuators, and/or the like).

As shown in FIG. 1, the work vehicle 10 includes a pair of front wheels 12, a pair or rear wheels 14, and a chassis 16 coupled to and supported by the wheels 12, 14. An operator's cab 18 may be supported by a portion of the chassis 16 and may house various control or input devices (e.g., levers, pedals, control panels, buttons and/or the like) for permitting an operator to control the operation of the work vehicle 10. For instance, as shown in FIG. 1, the work vehicle 10 includes one or more joysticks or control levers 20 for controlling the operation of one or more components of a lift assembly 22 of the work vehicle 10.

As shown in FIG. 1, the lift assembly 22 includes a pair of loader arms 24 (one of which is shown) extending lengthwise between a first end 26 and a second end 28. In this respect, the first ends 26 of the loader arms 24 may be pivotably coupled to the chassis 16 at pivot joints 30. Similarly, the second ends 28 of the loader arms 24 may be pivotably coupled to a suitable implement 32 of the work vehicle 10 (e.g., a bucket, fork, blade, and/or the like) at pivot joints 34. In addition, the lift assembly 22 also includes a plurality of hydraulic actuators for controlling the movement of the loader arms 24 and the implement 30. For instance, the lift assembly 22 may include a pair of hydraulic actuators in the form of hydraulic lift cylinders 36 (one of which is shown) coupled between the chassis 16 and the loader arms 24 for raising and lowering the loader arms 24 relative to the ground. Moreover, the lift assembly 22 may include a hydraulic actuators in the form of a pair of hydraulic tilt cylinders 38 (one of which is shown) for tilting or pivoting the implement 32 relative to the loader arms 24.

It should be appreciated that the configuration of the work vehicle 10 described above and shown in FIG. 1 is provided only to place the present subject matter in an exemplary field of use. Thus, it should be appreciated that the present subject matter may be readily adaptable to any manner of work vehicle configuration. For example, the work vehicle 10 was described above as including a pair of lift cylinders 36 and a pair of tilt cylinders 38. However, in other embodiments, the work vehicle 10 may, instead, include any number of hydraulic actuators (e.g., any number of lift cylinders 36 and/or tilt cylinders 38), such as by only including a single lift cylinder 36 for controlling the movement of the loader arms 24 and/or a single tilt cylinder 38 for controlling the movement of the implement 32. Additionally, in some embodiments, the work vehicle 10 may include other hydraulic actuators to actuate or otherwise operate other components of the vehicle 10.

The work vehicle 10 also includes an energy storage device 40 used to provide power for the work vehicle 10. In one form, the energy storage device 40 is sized to provide propulsive power to the work vehicle 10 as well as power used to operate the hydraulic actuators (e.g., any of hydraulic lift cylinders 36, 38). In some forms, the energy storage device 40 may be used in a hybrid powerplant environment where, for example, an internal combustion engine is used to provide intermittent power to the energy storage device 40, but not all embodiments of the work vehicle 10 need be hybrid. In one alternative form, the work vehicle is an all-electric work vehicle powered solely by the energy storage device 40.

The energy storage device 40 can include one or more energy storage devices 40 that work together to provide power to the work vehicle 40, whether the energy storage devices 40 are distributed around the work vehicle 10 or integrated together in a single location. The energy storage device 40 can be an electric storage device, such as an electric battery that, in some forms, is a lithium-ion battery. But other types of electric storage devices are also contemplated herein.

The energy storage device 40 can be integrated with an electric system controller 42 useful to manage a charging state of the energy storage device 40. The electric system controller 42 can stand on its own, or it can be incorporated into a vehicle controller useful to control other aspects of operation of the work vehicle 10. In one form, the electric system controller 42 can control the charging and discharging state of the energy storage device 40. For example, if the work vehicle 10 is configured to provide regenerative charging to the energy storage device 40, the electric system controller 42 can provide the necessary control required to manage the energy storage device 40 in conjunction with the source of regenerative power and any electric devices that are powered by the energy storage device 40.

In one form, the work vehicle 10 can include a regenerative charging capability for the energy storage device 40. The work vehicle 10 of the illustrated embodiment includes regenerative braking through use of a motor/generator 44 used to change propulsive power to the rear wheels 14. When a braking action is required in the rear wheels 14, the motor/generator 44 can be operated in a generator mode to slow down the work vehicle 10. When operated in the generator mode, the motor/generator 44 can be used to convert rotational energy of the rear wheels 14 to electricity, where such electricity is subsequently used to charge the energy storage device 40. Such regenerative charging through use of a motor/generator 44 on the rear wheels 14 can aid in extending the operational duration of the energy storage device 40. Although the illustrated embodiment depicts a motor/generator 44 only on the rear wheels 14, in other embodiments, the motor/generator 44 can alternatively and/or additionally be present on the front wheels 12.

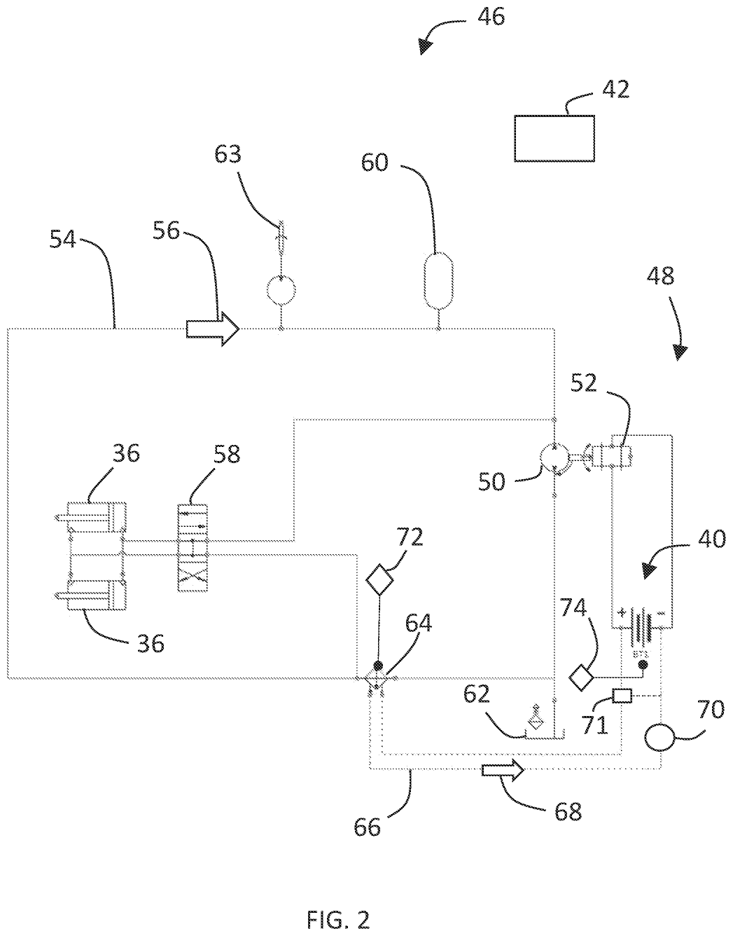

Turning now to FIG. 2, a schematic view of a hydraulic system 46 integrated with an electrical system 48 is illustrated, where heat created by virtue of operation of a hydraulic actuator(s) can be exchanged between the hydraulic system 46 and the electrical system 48. The exchange of heat between the hydraulic system 46 and electrical system 48 will be described further below. The hydraulic system 46 is further integrated with the electrical system 48 by virtue of a hydraulic pump 50 of the hydraulic system 46 being powered by an electric motor 52 of the electrical system 48.

The electric motor 52 can take any variety of useful forms, including direct current (DC) and alternating current (AC) motors. To set forth a few non-limiting examples, the electric motor 52 can be any of: AC brushless motors, DC brushed motors, DC brushless motors, and direct drive motors. The electric motor 52 can be sized to handle large power requirements necessary to pressurize the hydraulic fluid 56.

The hydraulic pump 50 can take any variety of forms useful to pressurize a hydraulic fluid 56 that provides the energy necessary to operate the hydraulic actuator (e.g., the hydraulic lift cylinders 36 and/or tilt cylinders 38). For example, the hydraulic pump 50 can take the form of a vane pump, gear pump, or piston pump, to set forth just a few non-limiting examples.

The hydraulic system 46 includes not only the hydraulic pump 50, but also several other components useful to provide operation of the hydraulic actuator, all of which are in fluid communication via a hydraulic fluid circuit 54 structured to contain the hydraulic fluid 56. The hydraulic fluid circuit 54 includes any number of conduit, piping, couplers, etc. useful to contain the hydraulic fluid and transmit pressure energy in the pressurized hydraulic fluid to the hydraulic actuator. Though the lead line used with respect to reference numeral 54 is connected to just one solid line of the schematic that represents the hydraulic fluid circuit 54, it will be appreciated that any of the solid lines used in the schematic to connect various components of the hydraulic fluid circuit 54 represent various fluid flow paths for the hydraulic fluid 56 of the hydraulic fluid circuit 54. Heat, which is generated from operation of the hydraulic system 46 to cause action of the hydraulic actuator, is absorbed into the hydraulic fluid of the hydraulic fluid circuit 54. Such heat generated from operation of the hydraulic system 46 can be considered waste heat as it is typically not needed, and can also be detrimental, to operation of the work vehicle 10 and/or components of the hydraulic system 46, including the hydraulic fluid itself.

In the embodiment illustrated in FIG. 2, the hydraulic actuator is shown as in the form of the hydraulic lift cylinders 36, but it will be appreciated that the hydraulic system 46 can also be used to provide power to other hydraulic actuators (e.g., the tilt cylinders 38). Further, the hydraulic lift cylinders 36 are illustrated in the form of double acting, linear hydraulic actuators, but other forms are also contemplated herein. For example, the hydraulic actuator can take any variety of forms, including a single acting, linear hydraulic actuator. Rotary hydraulic actuators are also contemplated. In short, no limitation is intended by the illustrated embodiment in FIG. 2, and, rather, any variety of hydraulic actuator is contemplated herein.

The hydraulic system 46 also includes a valve 58 useful to route a flow of hydraulic fluid 56 to an appropriate portion of the hydraulic lift cylinder 36 so as to create motion in the hydraulic lift cylinder 36. The valve 58 can take any form suitable for controlling the flow of hydraulic fluid 56 to and from the hydraulic lift cylinder 36. To set forth just one nonlimiting example, the valve 58 can be a spool valve capable of opening and closing various ports to direct a flow of the hydraulic fluid 56. In some forms, the valve 58 can include one or more solenoids useful to control, either directly or indirectly, the routing of hydraulic fluid 56.

An accumulator 60 can be included in the hydraulic system 46 to maintain pressure, reduce pressure peaks, and dampen pulsations of pressure in the hydraulic fluid 56. Though not depicted in the illustration, the accumulator can take on any variety of configurations, such as, but not limited to, bladder accumulators and piston accumulators.

A reservoir 62 can also be used in the hydraulic system 46 to hold the hydraulic fluid 56 and act as a buffer in case of excess fluid when the hydraulic system 46 is in operation. The reservoir 62 can take a variety of forms, such as, any of pressurized or unpressurized reservoir types. In some forms, the reservoir 62 can filter our foreign particulate matter from the hydraulic fluid 56.

The action of the hydraulic system 46 can be controlled via a control inceptor 63 such as, but not limited to, an operator wheel or stick located in the cab 18 of the work vehicle 10. Activation of the control inceptor 63, along with a load applied to the hydraulic lift cylinders 36, can be used to determine the amount of pumping required from the pump 50 as well as any routing needed by the valve 58 to move the hydraulic lift cylinders 36. In one embodiment, the electric system controller 42 could be used to orchestrate activation of the pump 50 and valve 58 based on the control inceptor 63. It is the pressurization of the hydraulic fluid 56 by virtue of the pump 50 and load applied to the hydraulic lift cylinder 36 that can create the waste heat in the hydraulic fluid. As will be appreciated, more active use of the hydraulic system 46 can create relatively more waste heat: less active use of the hydraulic system can create relatively less heat. The hydraulic fluid 56 can also absorb heat emitted through any other process (e.g., if the work vehicle 10 is a hybrid vehicle with internal combustion engine, the hydraulic fluid may also pick up heat by virtue of operation of the internal combustion engine).

In the illustrated embodiment of FIG. 2, the hydraulic system 46 is in thermal communication with the electrical system 48 via a hydraulic cooler 64. The hydraulic cooler 64 is used to transfer heat between the hydraulic fluid 56 and the electrical system 48 by placing a flow path of each of the hydraulic fluid circuit 54 and a heat exchange fluid circuit 66 in thermal communication with each other. The hydraulic cooler 64 can be made of any suitable thermally conductive material and includes any variety of fluid flow paths suitable to enable thermal communication between the hydraulic fluid circuit 54 and heat exchange fluid circuit 66.

The heat exchange fluid circuit 66 includes any number of conduits, piping, couplers, etc. useful to contain a heat exchange fluid 68 flowing therethrough. Though the lead line used with respect to reference numeral 68 is connected to just one dashed line of the schematic that represents the heat exchange fluid circuit 66, it will be appreciated that both dashed lines represent fluid flow paths for the heat exchange fluid 68 of the heat exchange fluid circuit 66. Heat, which is transferred from the hydraulic fluid 56 to the heat exchange fluid 68 via the hydraulic cooler 64 can be used to warm the energy storage device 40. As illustrated in FIG. 2, the heat exchange fluid circuit 66 includes fluid flow pathways that circulate the heat exchange fluid 68 between the energy storage device 40 and the hydraulic cooler 64. Heat transfer between the heat exchange fluid 68 in the heat exchange fluid circuit 66 and the energy storage device 40 can be either through convective and/or conductive heat transfer. For example, in some forms, the heat exchange fluid circuit 66 includes a flow path that is in thermally conductive relationship with the energy storage device 40. To set forth just one non-limiting example, the energy storage device 40 may include a flow pathway integrated into a housing of the energy storage device 40. In another form, the energy storage device 40 may be located in a compartment which is warmed through convective heat transfer by the heat exchange fluid 68 in the heat exchange fluid circuit 66.

The heat exchange fluid circuit 66 can also include a fluid pump 70 having a moveable mechanical component useful to provide motive force to the heat exchange fluid 68 to encourage circulation. The fluid pump 70 can take any variety of forms useful to convey the heat exchange fluid 68. For example, the fluid pump 70 can take the form of a vane pump, gear pump, or piston pump, to set forth just a few non-limiting examples. The fluid pump 70 can be driven by an electric motor, similar to electric motor 52, which can be powered by the energy storage device 40. The electric motor used to drive the fluid pump 70 can be energized based upon a command by the electric system controller 42. The fluid pump 70 can, therefore, be placed in an ON condition by action of the electric system controller 42 (e.g., when the electric motor associated with the fluid pump 70 is energized by the electric system controller 42) where the ON condition is useful to circulate the heat exchange fluid 68. Similarly, the fluid pump 70 can be placed in an OFF condition by action of the electric system controller 42 (e.g., when the electric motor associated with the fluid pump 70 is not energized by the electric system controller 42) where the OFF condition is useful to discourage circulation of the heat exchange fluid 68.

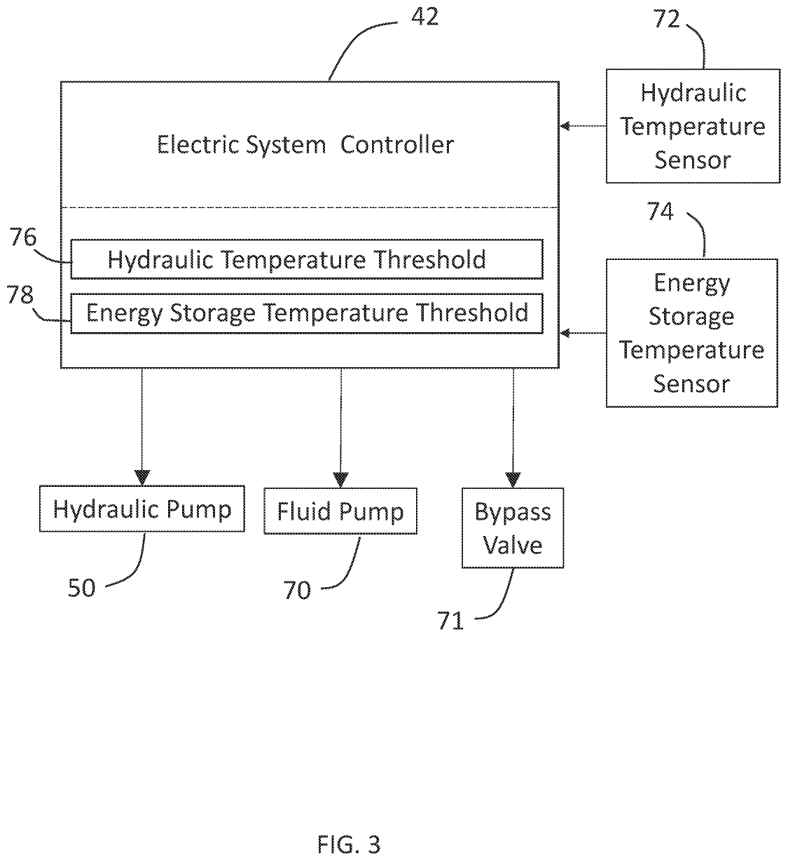

Turning now to FIG. 3, and with continued reference to FIG. 2, the electrical system 48 can be placed in thermal communication with the hydraulic system 46 by selective activation of the fluid pump 70. Such selective activation, as suggested above, can be performed by the electric system controller 42 based on temperature measurements of components within the system illustrated in FIG. 2. To determine whether the fluid pump 70 should be energized to circulate the heat exchange fluid 68 within the heat exchange fluid circuit 66, at least two temperature sensors are provided in the illustrated embodiment. A hydraulic temperature sensor 72 can be provided to generate a hydraulic temperature indicative of a temperature of the hydraulic fluid 56. The hydraulic temperature sensor 72 can be placed at any location in the hydraulic system 46, but in the illustrated embodiment, it is located at the hydraulic cooler 64 to determine temperature of the hydraulic fluid 56 in proximity to a location in which heat transfer occurs between the hydraulic fluid 56 and the heat exchange fluid 68. An energy storage temperature sensor 74 can be provided to generate an energy storage temperature indicative of a temperature of the energy storage device 40.

The electric system controller 42 can generate a control signal based on the hydraulic temperature to place the fluid pump 70 in an ON condition when the hydraulic temperature is above a hydraulic threshold temperature 76. Such control logic can be used to conserve energy of the energy storage device 40 if insufficient heat exists within the hydraulic fluid 56 to aid in warming the energy storage device 40. This control logic can also be paired with the energy storage temperature. For example, the electric system controller 42 can generate a control signal based on the hydraulic temperature and the energy storage temperature to place the fluid pump 70 in an ON condition when a comparison between the hydraulic temperature and the energy storage temperature exceeds a comparison threshold. Such control logic can be used to conserve energy of the energy storage device 40 if insufficient heat exists within the hydraulic fluid 56 to aid in further warming the energy storage device 40.

Similar to the above, the electric system controller 42 can generate a control signal based on the energy storage temperature to place the fluid pump 70 in an OFF condition when the energy storage temperature is above an energy storage threshold temperature 78. Such control logic can be used to prevent overheating of the energy storage device 40 if an excess amount of heat exists within the hydraulic fluid 56.

In some embodiments, such as in FIG. 2, a bypass valve 71 can also be used to redirect a flow of heat exchange fluid 68 when the bypass valve 71 is configured to flow heat exchange fluid through a bypass conduit when the bypass valve 71 is placed in a bypass condition. Correspondingly, the bypass valve 71 can be in a no-bypass condition when the bypass valve 71 is configured to restrict a flow of heat exchange fluid through the bypass conduit when the bypass valve 71 is in a no-bypass condition. Not all embodiments may include the bypass valve 71. In one embodiment, while the bypass valve 71 is in the bypass condition, the bypass valve 71 can regulate an amount of heat exchange fluid 68 to be routed to the energy storage device 40 for heat transfer. For example, the bypass valve 71 can be placed in a bypass condition which provides a fixed flow of heat exchange fluid 68. In an alternative form, the bypass valve 71 is a variable bypass valve capable of being controlled to vary a flow of heat exchange fluid 68 through the bypass valve 71 and away from the energy storage device 40. As will be appreciated, the bypass valve 71 can be a proportional valve. A variable bypass valve 71 can have a bypass condition characterized by a variable flow of heat exchange fluid 68, including a flow of heat exchange fluid 68 that ranges from no-bypass flow to full bypass flow. The bypass valve 71 can be placed in the bypass condition or no-bypass condition by the electric system controller 42, either independent of the fluid pump 70 or in conjunction with the fluid pump 70, to regulate a flow of the heat exchange fluid 68. In some forms, the fluid pump 70 can be a constant speed pump, with the bypass valve 71 used to control the flow of heat exchange fluid 68 to the energy storage device 40. Given the discussion above of the various embodiments of bypass valves 71, it will be appreciated that one embodiment of a bypass valve 71 may have only two configurations, one of which permits a bypass flow of heat exchange fluid 68 (e.g., a bypass condition), and the other of which prohibits a variable bypass flow of heat exchange fluid 68 (e.g., a no-bypass condition). Correspondingly, it will be appreciated that in another embodiment, the bypass valve 71 in the form of a variable bypass valve 71 can include a bypass condition characterized by a variable flow of heat exchange fluid 68 ranging from no-bypass flow to one or more rates of a bypass flow.

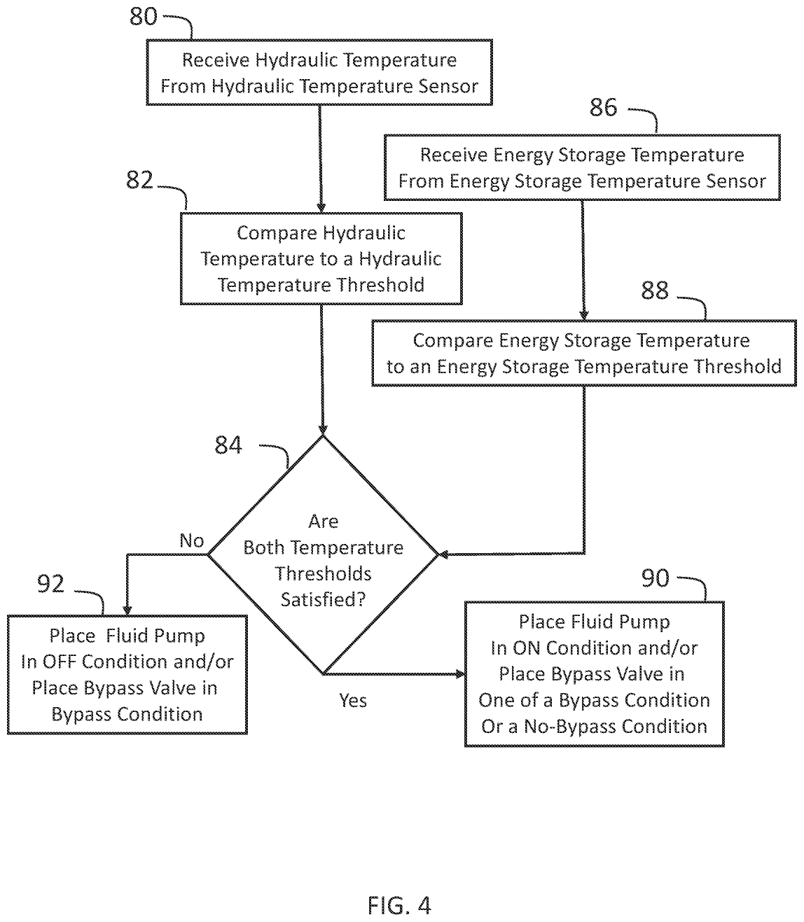

FIG. 4 depicts a flow chart having two logic paths used to determine whether the fluid pump 70 is placed in an ON or an OFF condition and/or whether the bypass valve 71 is in a no-bypass condition or bypass condition, depending on the type of bypass valve 71. Though FIG. 4 depicts two logic paths, it will be appreciated that in other embodiments, only one of the two need be present. Furthermore, given the discussion above related to other logic paths to determine whether to place the fluid pump 70 in an ON or OFF condition, additional and/or alternative logic paths can be used. Thus, no limitation is intended related to any particular logic path used in the electric system controller 42 with respect to placing the fluid pump 70 in either the ON or OFF condition.

Starting at block 80, the electric system controller 42 is configured to receive the hydraulic temperature from the hydraulic temperature sensor 72. The hydraulic temperature is compared, at block 82, to the hydraulic threshold temperature. Block 84 includes two steps, the first is to evaluate the hydraulic temperature against the hydraulic threshold temperature 76 (e.g., compare whether or not the hydraulic temperature equals and/or exceeds the hydraulic threshold temperature). The second step of block 84 relies upon the energy storage temperature. At block 86, the electric system controller 42 is configured to receive the energy storage temperature from the energy storage temperature sensor 72. The energy storage temperature is compared, at block 88, to the energy storage threshold temperature. Block 84, in its second step, evaluates the energy storage temperature against the energy storage threshold temperature 78 (e.g., compare whether or not the energy storage temperature equals and/or falls below the energy storage threshold temperature). Block 84, in sum, determines whether the hydraulic temperature satisfies the hydraulic threshold temperature 76 (e.g., whether or not the hydraulic temperature equals and/or exceeds the hydraulic threshold temperature) and whether the energy storage temperature satisfies the energy storage threshold temperature (e.g., whether or not the energy storage temperature equals and/or falls below the energy storage threshold temperature). If both conditions are satisfied, the logic flow in FIG. 4 moves to block 90 whereupon the electric system controller 42 places the fluid pump 70 in the ON condition. If neither, or only one, of the conditions evaluated in block 84 are satisfied, the logic flow moves to block 92 whereupon the electric system controller 42 places the fluid pump 70 in the OFF condition.

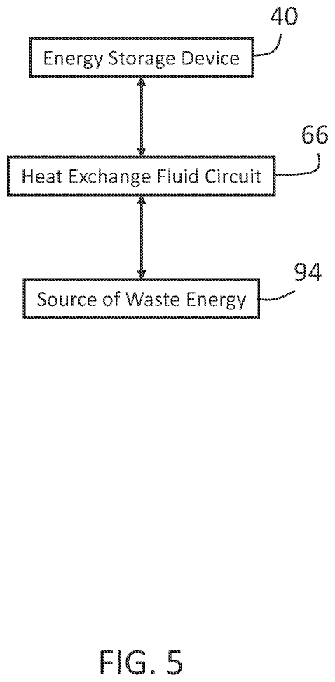

Turning to FIG. 5, although the description above includes embodiments directed to transferring waste heat from a hydraulic system 46 to an energy storage device 40, other embodiments can include capturing waste energy from other systems of the work vehicle 10 to manage thermal conditions of the energy storage device 40. The other systems of the work vehicle that serve as a source of waste energy can be referred to herein as a source of waste energy 94. To set forth just one non-limiting example, waste energy in the form of excess heat from the cab 18 (e.g., heat generated to keep the cab 18 warm for an operator) can be captured and transferred to the energy storage device 40. Such a system might take the form of the heat exchange fluid circuit in thermal communication with the cab 18 and/or a heater used to heat the cab 18 (as opposed to being in communication with the hydraulic cooler 64), where heat from the cab 18/heater can be used to warm the heat exchange fluid 68. As will be appreciated in the context of FIG. 5, the cab 18 and/or heater used to heat the cab can be referred to herein as a source of waste energy 94. The heat exchange fluid 68, in turn, can be used to warm the energy storage device 40. Similar use of the electric system controller 42, fluid pump 70, and the energy storage temperature sensor 74 as described above are also contemplated.

To set forth another non-limiting example of capturing waste energy from other systems of the work vehicle 10 to manage thermal conditions of the energy storage device 40, waste energy in the form of excess cooling from the cab 18 (e.g., cooling generated to keep the cab 18 cool for an operator on a warm day) can be captured and transferred to the energy storage device 40. Such a system might take the form of the heat exchange fluid circuit in thermal communication with the cab 18 and/or a cooler used to cool the cab 18 (as opposed to being in communication with the hydraulic cooler 64), where cooling from the cab 18/cooler can be used to cool the heat exchange fluid 68. As will be appreciated in the context of FIG. 5, the cab 18 and/or cooler used to cool the cab can be referred to herein as source of waste energy 94. The heat exchange fluid 68, in turn, can be used to cool the energy storage device 40. Similar use of the electric system controller 42, fluid pump 70, and the energy storage temperature sensor 74 as described above are also contemplated, albeit with a potential change to place the fluid pump 70 in an ON condition if the energy storage temperature is at or above an energy storage threshold temperature 78.

In both of the examples above, the cab 18 and/or either a heater or cooler associated with providing the environmental conditions to the cab 18 can be referred to as a source of waste energy. Furthermore, the hydraulic system 46 discussed above can also be referred to as a source of waste energy.

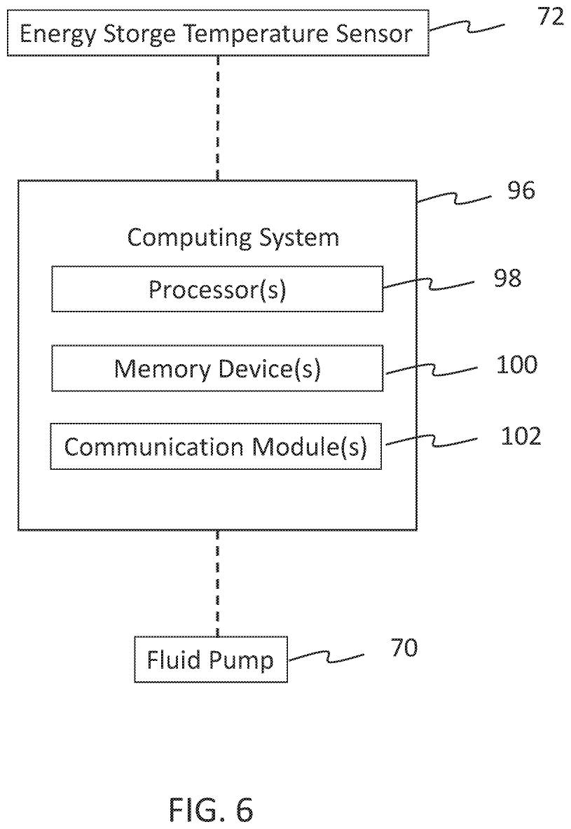

Referring now to FIG. 6, embodiments of the systems and methods disclosed herein may include a computing system 96 communicatively coupled to the energy storage temperature sensor 72, as well as the fluid pump 70. Although the hydraulic temperature sensor 74 could also be illustrated, along with several other components of the work vehicle 10, FIG. 6 illustrates only the energy storage temperature sensor 72 and fluid pump 70 for sake of brevity. The computing system 96 depicted in FIG. 6 can be the electric system controller 42 described and depicted above.

In general, the computing system 96 may include suitable algorithms, mathematical formulas or expressions, predetermination relationships, correlation tables, look-up tables, and/or other data stored within its memory that allows the computing system 96 to determine, calculate, or estimate any data associated with the energy storage temperature sensor 72.

In general, the computing system 96 may comprise any suitable processor-based device known in the art, such as a computing device or any suitable combination of computing devices. Thus, in several embodiments, the computing system 96 may include one or more processor(s) 98 and associated memory device(s) 100 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 100 of the computing system 96 may generally comprise memory element(s) including, but not limited to, a computer readable medium (e.g., random access memory (RAM)), a computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 100 may generally be configured to store suitable computer-readable instructions that, when implemented by the processor(s) 98, configure the computing system 96 to perform various computer-implemented functions, such as one or more aspects of the methods or algorithms described herein. In addition, the computing system 96 may also include various other suitable components, such as a communications circuit or module, one or more input/output channels, a data/control bus and/or the like. For instance, the computing system 96 may include a communications module or interface 102 to allow the computing system 96 to communicate with any of the various other system components described herein, such as the hydraulic temperature sensor 72 and/or the hydraulic pump 50.

It should be appreciated that, in several embodiments, the computing system 96 may correspond to a stand-alone computing system separate and apart from other computing systems. Additionally, in some embodiments, the computing system 96 may correspond to or form part of an existing on-board computing system.

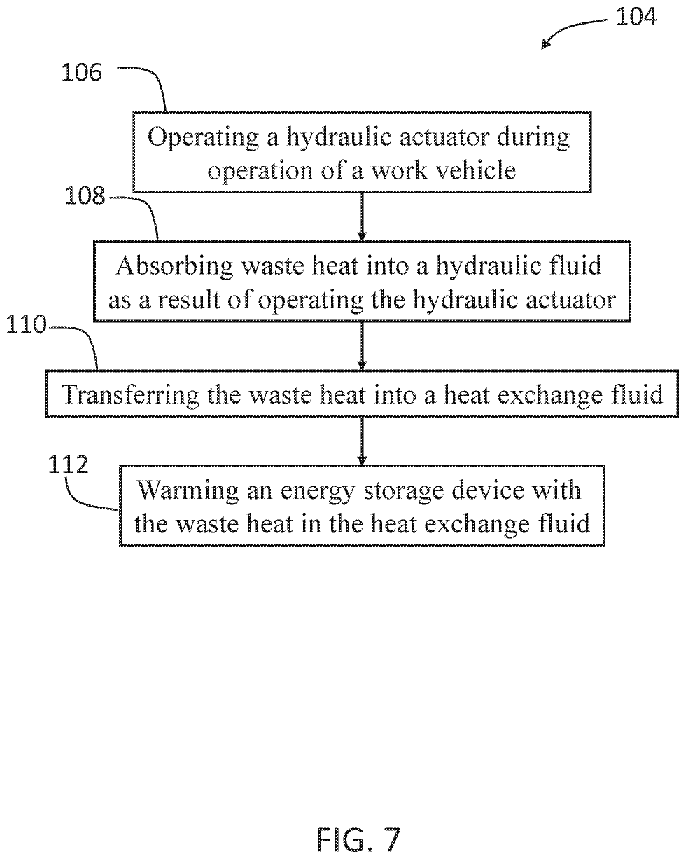

Turning now to FIG. 7, a flow diagram of one embodiment of a method 104 is provided for using waste heat. In general, the method 106 will be described herein with reference to the work vehicle 10 described and depicted in FIG. 1. However, it should be appreciated by those of ordinary skill in the art that the disclosed method 104 may generally be implemented with any work vehicle 10 having any suitable configuration. In addition, although FIG. 7 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 7, at step 106, the method 104 may include operating a hydraulic actuator during operation of a work vehicle. At step 108, the method may further include absorbing waste heat into a hydraulic fluid as a result of operating the hydraulic actuator. At step 110, the method may further include transferring the waste heat into a heat exchange fluid. At step 112, the method may further include warming an energy storage device with the waste heat in the heat exchange fluid. It is to be understood that the steps of the method 104 are performed by the computing system 96 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the computing system 96 described herein, such as the method 104, is implemented in software code or instructions which are tangibly stored on a tangible computer readable medium. The computing system 96 loads the software code or instructions via a direct interface with the computer readable medium or via a wired and/or wireless network. Upon loading and executing such software code or instructions by the computing system 96, the computing system 96 may perform any of the functionality of the computing system 96 described herein, including any steps of the method 104 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A system for exchanging heat to support operation of an electrical system, the system comprising:
a hydraulic actuator structured to receive a pressurized hydraulic fluid and convert a pressure energy in the pressurized hydraulic fluid to mechanical force;
a hydraulic fluid circuit structured to contain the pressurized hydraulic fluid and transmit the pressure energy to the hydraulic actuator, the hydraulic fluid circuit also configured to absorb a waste heat produced as a result of operation of the hydraulic actuator;
a heat exchange fluid circuit in thermal communication with the hydraulic fluid circuit, the heat exchange fluid circuit structured to contain a heat exchange fluid; and
an energy storage device in thermal communication with the heat exchange fluid, wherein as a result of the energy storage device being in thermal communication with the heat exchange fluid, the heat exchange fluid transfers the waste heat from the pressurized hydraulic fluid to the energy storage device.

2. The system for exchanging heat of claim 1, which further includes a hydraulic pump structured to produce the pressure energy in the hydraulic fluid.

3. The system for exchanging heat of claim 2, wherein the energy storage device is used to provide electric energy to an electric motor, the electric motor configured to convert electrical energy to motive force, the motive force of the electric motor used to provide power to the hydraulic pump.

4. The system for exchanging heat of claim 3, wherein the energy storage device is configured to receive a regeneration charge.

5. The system for exchanging heat of claim 1, wherein the heat exchange fluid circuit includes a fluid pump structured to produce a motive force to encourage circulation of the heat exchange fluid in the heat exchange fluid circuit.

6. The system for exchanging heat of claim 5, which further includes a hydraulic temperature sensor configured to generate a hydraulic temperature indicative of a temperature of the pressurized hydraulic fluid.

7. The system for exchanging heat of claim 6, which further includes a controller configured to place the fluid pump in an ON condition when the hydraulic temperature is above a threshold temperature.

8. The system for exchanging heat of claim 1, wherein the hydraulic fluid circuit further includes a hydraulic cooler, the hydraulic cooler structured to exchange heat between the pressurized hydraulic fluid and the heat exchange fluid.

9. A system for transferring waste energy comprising:
a work vehicle configured to generate a waste energy as a result of operation of the work vehicle, the work vehicle including:
a heat exchange fluid circuit in thermal communication with a source of the waste energy, the heat exchange fluid circuit structured to contain a heat exchange fluid; and
an energy storage device in thermal communication with the heat exchange fluid, wherein as a result of the energy storage device being in thermal communication with the heat exchange fluid, the heat exchange fluid transfers the waste energy between the source of waste energy and the energy storage device.

10. The system for transferring waste energy of claim 9, which further includes a fluid pump configured to circulate the heat exchange fluid in the heat exchange fluid circuit, the fluid pump having an ON condition to circulate the heat exchange fluid and an OFF condition to discourage circulation of the heat exchange fluid.

11. The system for transferring waste energy of claim 10, wherein the source of waste energy is a hydraulic system having a hydraulic temperature sensor configured to generate a hydraulic temperature indicative of a temperature of a hydraulic fluid.

12. The system for transferring waste energy of claim 11, which further includes a controller configured to place at least one of the pump in the OFF condition or a bypass valve to redirect flow in a bypass condition, if a hydraulic temperature is below a threshold temperature.

13. The system for transferring waste energy of claim 10, which further includes an energy storage temperature sensor configured to generate an energy storage temperature indicative of a temperature of the energy storage device.

14. The system for transferring waste energy of claim 13, which further includes a controller configured to place at least one of the pump in the OFF condition or a bypass valve to redirect flow in a bypass condition, if the energy storage temperature is above a threshold temperature.

15. The system for transferring waste energy of claim 10, wherein the fluid pump is a variable speed fluid pump.

16. The system for transferring waste energy of claim 9, wherein the energy storage device is configured to receive a regeneration charge as a result of operation of the work vehicle.

17. A method for using waste heat, the method comprising:
operating a hydraulic actuator during operation of a work vehicle;
absorbing waste heat into a hydraulic fluid as a result of operating the hydraulic actuator;
transferring the waste heat into a heat exchange fluid; and
warming an energy storage device with the waste heat in the heat exchange fluid.

18. The method of claim 17, which further includes selectively warming the energy storage device based on a temperature of at least one of the energy storage device and the hydraulic fluid.

19. The method of claim 17, which further includes regenerative charging the energy storage device as a result of operation of the work vehicle during the warming of the energy storage device.

20. The method of claim 17, which further includes providing an electrical energy from the energy storage device to an electric motor used to drive the hydraulic actuator.
